(19) United States
(12) Patent Application Publication
(10) Pub. No.: US 2015/0039645 A1
(43) Pub. Date: Feb. 5, 2015

(54) High-Performance Distributed Data Storage System with Implicit Content Routing and Data Deduplication

(71) Applicant: Formation Data Systems, Inc., Fremont, CA (US)

(72) Inventor: Mark S. Lewis, Pleasanton, CA (US)

(73) Assignee: Formation Data Systems, Inc., Fremont, CA (US)

(21) Appl. No.: 13/957,849

(22) Filed: Aug. 2, 2013

(51) Int. Cl. G06F 17/30

(52) U.S. Cl. CPC G06F 17/30424
USPC 707/769

(57) ABSTRACT

A write request that includes a data object is processed. A hash function is executed on the data object, thereby generating a hash value that includes a first portion and a second portion. A data location table is queried with the first portion, thereby obtaining a storage node identifier. The data object is sent to a storage node associated with the storage node identifier. A write request that includes a data object and a pending data object identification (DOID) is processed, wherein the pending DOID comprises a hash value of the data object. The pending DOID is finalized, thereby generating a finalized data object identification (DOID). The data object is stored at a storage location. A storage manager catalog is updated by adding an entry mapping the finalized DOID to the storage location. The finalized DOID is output.

### BACKGROUND

1. Technical Field

The present invention generally relates to the field of data storage and, in particular, to a data storage system with implicit content routing and data deduplication.

2. Background Information

Scale-out storage systems (also known as horizontally-scalable storage systems) offer many preferred characteristics over scale-up storage systems (also known as vertically-scalable storage systems or monolithic storage systems). Scale-out storage systems can offer more flexibility, more scalability, and improved cost characteristics and are often easier to manage (versus multiple individual systems). Scale-out storage systems' most common weakness is that they are limited in performance, since certain functional elements, like directory and management services, must remain centralized. This performance issue tends to limit the scale of the overall system.

### SUMMARY

The above and other issues are addressed by a computer-implemented method, non-transitory computer-readable storage medium, and computer system for storing data with implicit content routing and data deduplication. An embodiment of a method for processing a write request that includes a data object comprises executing a hash function on the data object, thereby generating a hash value that includes a first portion and a second portion. The method further comprises querying a data location table with the first portion, thereby obtaining a storage node identifier. The method further comprises sending the data object to a storage node associated with the storage node identifier.

An embodiment of a method for processing a write request that includes a data object and a pending data object identification (DOID), wherein the pending DOID comprises a hash value of the data object, comprises finalizing the pending DOID, thereby generating a finalized data object identification (DOID). The method further comprises storing the data object at a storage location. The method further comprises updating a storage manager catalog by adding an entry mapping the finalized DOID to the storage location. The method further comprises outputting the finalized DOID.

An embodiment of a medium stores computer program modules for processing a read request that includes an application data identifier, the computer program modules executable to perform steps. The steps comprise querying a virtual volume catalog with the application data identifier, thereby obtaining a data object identification (DOID). The DOID comprises a hash value of a data object. The hash value includes a first portion and a second portion. The steps further comprise querying a data location table with the first portion, thereby obtaining a storage node identifier. The steps further comprise sending the DOID to a storage node associated with the storage node identifier.

An embodiment of a computer system for processing a read request that includes a data object identification (DOID), wherein the DOID comprises a hash value of a data object, and wherein the hash value includes a first portion and a second portion, comprises a non-transitory computer-readable storage medium storing computer program modules executable to perform steps. The steps comprise querying a storage manager catalog with the first portion, thereby obtaining a storage location. The steps further comprise retrieving the data object from the storage location.

### BRIEF DESCRIPTION OF THE DRAWINGS

FIG. 1 is a high-level block diagram illustrating an environment for storing data with implicit content routing and data deduplication, according to one embodiment.

FIG. 2 is a high-level block diagram illustrating an example of a computer for use as one or more of the entities illustrated in FIG. 1, according to one embodiment.

FIG. 3 is a high-level block diagram illustrating the storage hypervisor module from FIG. 1, according to one embodiment.

FIG. 4 is a high-level block diagram illustrating the storage manager module from FIG. 1, according to one embodiment.

FIG. 5 is a sequence diagram illustrating steps involved in processing an application write request, according to one embodiment.

FIG. 6 is a sequence diagram illustrating steps involved in processing an application read request, according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

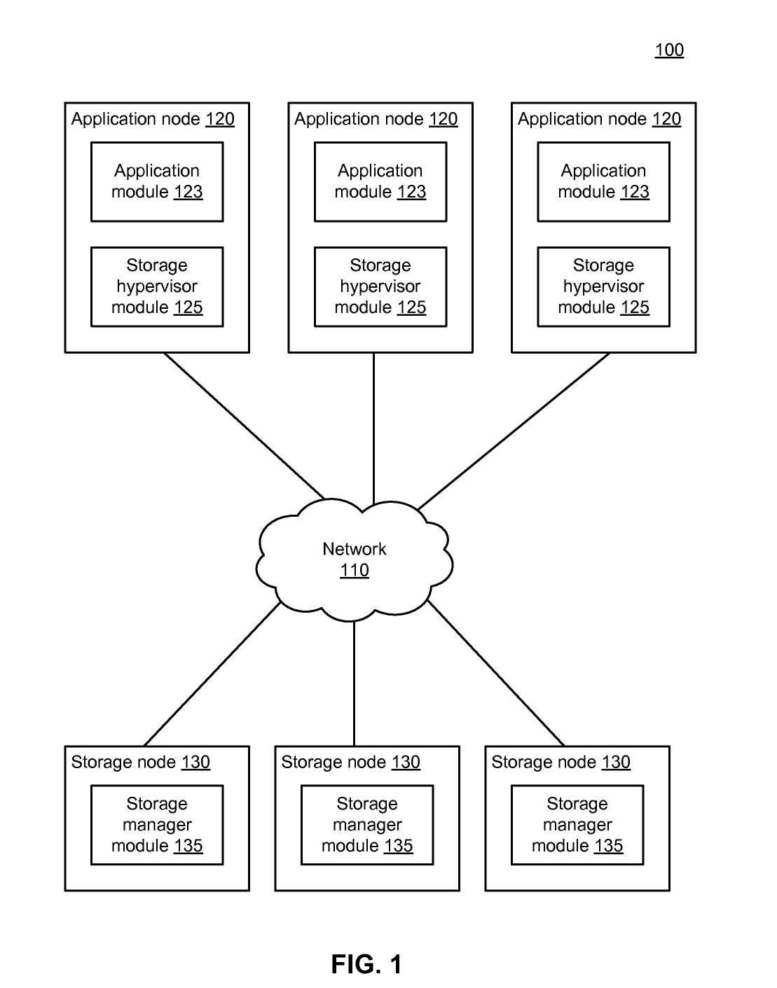

FIG. 1 is a high-level block diagram illustrating an environment 100 for storing data with implicit content routing and data deduplication, according to one embodiment. The environment 100 may be maintained by an enterprise that enables data to be stored with implicit content routing and data deduplication, such as a corporation, university, or government agency. As shown, the environment 100 includes a network 110, multiple application nodes 120, and multiple storage nodes 130. While three application nodes 120 and three storage nodes 130 are shown in the embodiment depicted in FIG. 1, other embodiments can have different numbers of application nodes 120 and/or storage nodes 130.

The network 110 represents the communication pathway between the application nodes 120 and the storage nodes 130. In one embodiment, the network 110 uses standard communications technologies and/or protocols and can include the Internet. Thus, the network 110 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 110 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the network 110 can be represented using technologies and/or formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities on the network 110 can use custom and/or dedicated data communications technologies instead of, or in addition to, the ones described above.

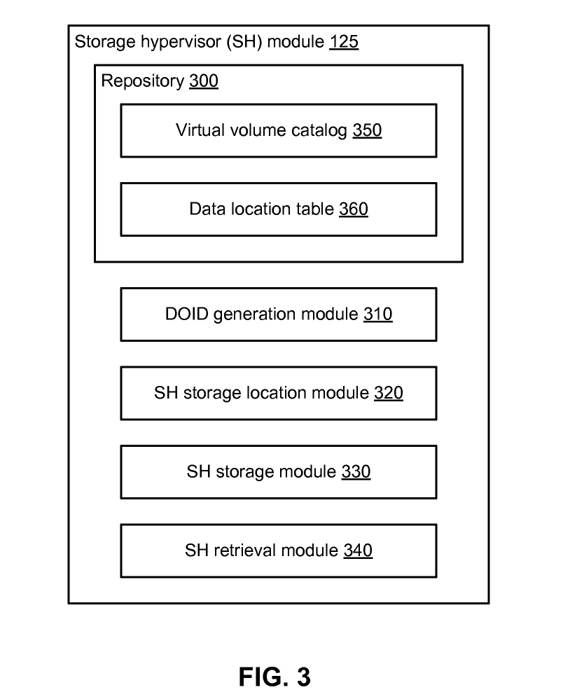

An application node 120 is a computer (or set of computers) that provides standard application functionality and data services that support that functionality. The application node 120 includes an application module 123 and a storage hypervisor module 125. The application module 123 provides standard application functionality such as serving web pages, archiving data, or data backup/disaster recovery. In order to provide this standard functionality, the application module 123 issues write requests (i.e., requests to store data) and read requests (i.e., requests to retrieve data). The storage hypervisor module 125 handles these application write requests and application read requests. The storage hypervisor module 125 is further described below with reference to FIGS. 3 and 5-6.

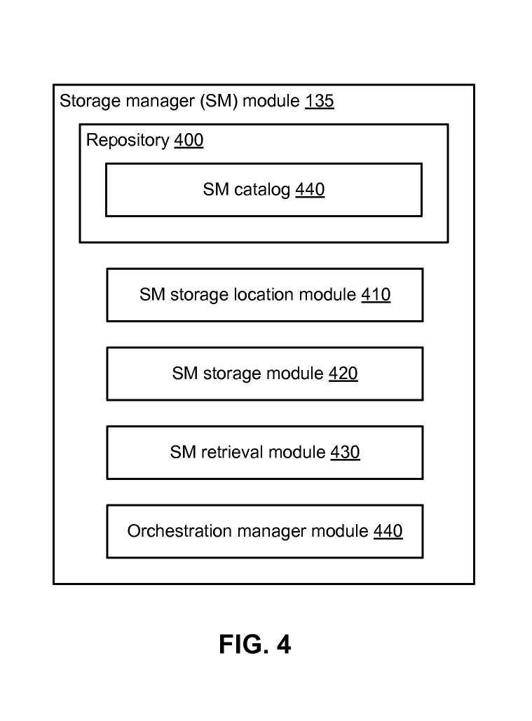

A storage node 130 is a computer (or set of computers) that stores data. The storage node 130 can include one or more types of storage, such as hard disk, optical disk, flash memory, and cloud. The storage node 130 includes a storage manager module 135. The storage manager module 135 handles data requests received via the network 110 from the storage hypervisor module 125 (e.g., storage hypervisor write requests and storage hypervisor read requests). The storage manager module 135 is further described below with reference to FIGS. 4-6.

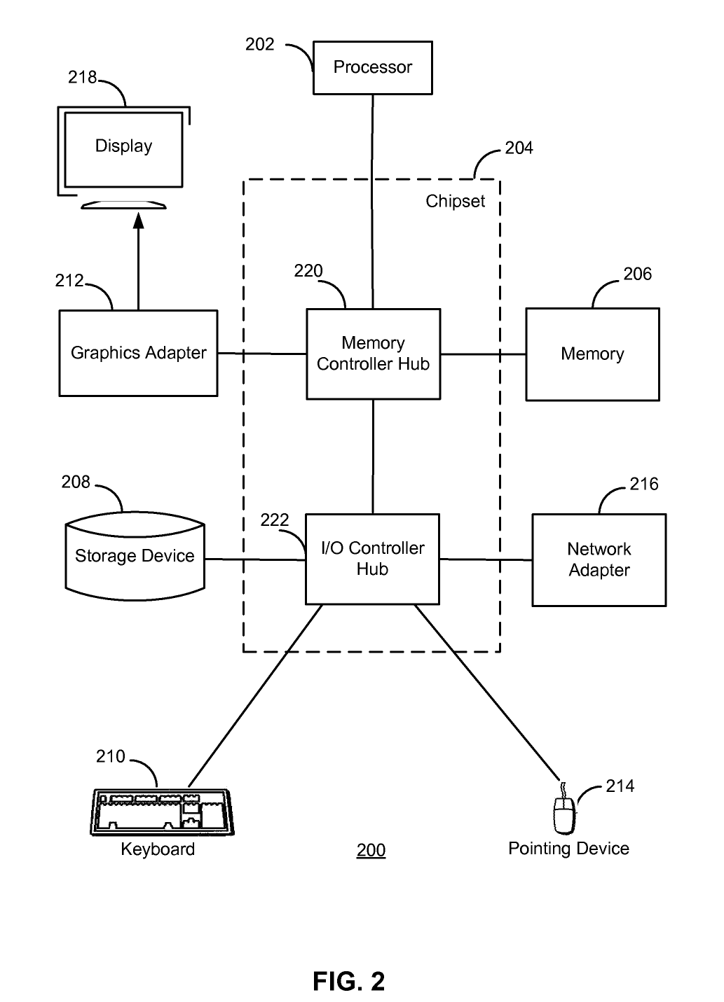

FIG. 2 is a high-level block diagram illustrating an example of a computer 200 for use as one or more of the entities illustrated in FIG. 1, according to one embodiment. Illustrated are at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 includes one or more non-transitory computer-readable storage media such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 212 displays images and other information on the display device 218. In some embodiments, the display device 218 includes a touch screen capability for receiving user input and selections. The network adapter 216 couples the computer system 200 to the network 110. Some embodiments of the computer 200 have different and/or other components than those shown in FIG. 2. For example, the application node 120 and/or the storage node 130 can be formed of multiple blade servers and lack a display device, keyboard, and other components.

The computer 200 is adapted to execute computer program modules for providing functionality described herein. As used herein, the term “module” refers to computer program instructions and/or other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

FIG. 3 is a high-level block diagram illustrating the storage hypervisor module 125 from FIG. 1, according to one embodiment. The storage hypervisor (SH) module 125 includes a repository 300, a DOID generation module 310, a storage hypervisor (SH) storage location module 320, a storage hypervisor (SH) storage module 330, and a storage hypervisor (SH) retrieval module 340. The repository 300 stores a virtual volume catalog 350 and a data location table 360.

The virtual volume catalog 350 stores mappings between application data identifiers and data object identifications (DOIDs). One application data identifier is mapped to one DOID. The application data identifier is the identifier used by the application module 123 to refer to the data within the application. The application data identifier can be, for example, a file name, an object name, or a range of blocks. The DOID is a unique address that is used as the primary reference for placement and retrieval of a data object (DO). In one embodiment, the DOID is a 21-byte value. Table 1 shows the information included in a DOID, according to one embodiment.

TABLE 1
DOID Attributes

| Attribute Name | Attribute Size | Attribute Description |
|---|---|---|
| Base_Hash | 16 bytes | Bytes 0-3: Used by the storage hypervisor |
| | | module for data object routing and location |
| | | with respect to various storage nodes |
| | | (“DOID Locator (DOID-L)”). Since the |
| | | DOID-L portion of the DOID is used for |
| | | routing, the DOID is said to support |
| | | “implicit content routing.” |
| | | Bytes 4-5: Can be used by the storage |
| | | manager module for data object placement |
| | | acceleration within a storage node (across |
| | | individual disks) in a similar manner to the |
| | | data object distribution model used across |
| | | the storage nodes. |
| | | Bytes 6-15: Used as a unique identifier for |
| | | the data object. |
| Conflict_ID | 1 byte | Used to distinguish among different data |
| | | objects that have the same Base_Hash value. |
| | | Default value starts at 00. FF is reserved. |
| Object_Size (L) | 1 byte | Denotes number of full 1 MB segments in |
| | | data object (1 = 1 × 1 MB, 2 = 2 × 1 MB, |
| | | 3 = 3 × 1 MB, etc). This value (in conjunction |
| | | with the Object_Size (S) value) is used by |
| | | the storage manager module to confirm that |
| | | a data object of proper size is written or read. |
| Object_Size (S) | 1 byte | Denotes number of 4K (4096-byte) blocks in |
| | | data object (beyond the Object_Size (L)) |
| | | (1 = 1 × 4K, 2 = 2 × 4K, 3 = 3 × 4K, etc). This value |
| | | (in conjunction with the Object_Size (L) |
| | | value) is used by the storage manager |
| | | module to confirm that a data object of |
| | | proper size is written or read. |
| Process | 1 byte | Used for state management. For example, |
| | | this byte can be used during the write |
| | | process to identify a data object that is in the |
| | | process of being written. If a failure occurs |
| | | during the write process, then this value |
| | | enables the proper memory state to be |
| | | recovered more easily. |
| Archive | 1 byte | Denotes archive location, if any (00 = no |
| | | archive, 01 = local archive, 02 = site 2 |
| | | archive, etc.). Sites are assigned for each |
| | | storage volume. This value can be used to |
| | | indicate that a data object has been moved to |
| | | an archival storage system and is no longer |
| | | in the local storage. |

The data location table 360 stores data object placement information, such as mappings between DOID Locators (“DOID-Ls”, the first 4 bytes of DOIDs) and storage nodes. One DOID-L is mapped to one or more storage nodes (indicated by storage node identifiers). A storage node identifier is, for example, an IP address or another identifier that can be directly associated with an IP address. In one embodiment, the mappings are stored in a relational database to enable rapid access.

For a particular DOID-L, the identified storage nodes indicate where a data object (DO) (corresponding to the DOID-L) is stored or retrieved. In one embodiment, a DOID-L is a four-byte value that can range from [00 00 00 00] to [FF FF FF FF], which provides more than 429 million individual data object locations. Since the environment 100 will generally include fewer than 1000 storage nodes, a storage node would be allocated many (e.g., thousands of) DOID-Ls to provide a good degree of granularity. In general, more DOID-Ls are allocated to a storage node 130 that has a larger capacity, and fewer DOID-Ls are allocated to a storage node 130 that has a smaller capacity.

The DOID generation module 310 takes as input a data object (DO), generates a data object identification (DOID) for that object, and outputs the generated DOID. In one embodiment, the DOID generation module 310 generates the DOID by determining a value for each DOID attribute as follows:

Base_Hash—The DOID generation module 310 executes a specific hash function on the DO and uses the hash value as the Base_Hash attribute. In general, the hash algorithm is fast, consumes minimal CPU resources for processing, and generates a good distribution of hash values (e.g., hash values where the individual bit values are evenly distributed). The hash function need not be secure. In one embodiment, the hash algorithm is MurmurHash3, which generates a 128-bit value.

Note that the Base_Hash attribute is “content specific,” that is, the value of the Base_Hash attribute is based on the data object (DO) itself. Thus, identical files or data sets will always generate the same Base_Hash attribute (and, therefore, the same DOID-L). Since data objects (DOs) are automatically distributed across individual storage nodes 130 based on their DOID-Ls, and DOID-Ls are content-specific, then duplicate DOs (which, by definition, have the same DOID-L) are always sent to the same storage node 130. Therefore, two independent application modules 123 on two different application nodes 120 that store the same file will have that file stored on exactly the same storage node 130 (because the Base_Hash attributes of the data objects, and therefore the DOID-Ls, match). Since the same file is sought to be stored twice on the same storage node 130 (once by each application module 123), that storage node 130 has the opportunity to minimize the storage footprint through the consolidation or deduplication of the redundant data (without affecting performance or the protection of the data).

Conflict_ID—The odds of different data objects having the same Base_Hash value are very low (e.g., 1 in 16 quintillion). Still, a hash collision is theoretically possible. A conflict can arise if such a hash collision occurs. In this situation, the Conflict_ID attribute is used to distinguish among the conflicting data objects. The DOID generation module 310 assigns a default value of 00. Later, the default value is overwritten if a hash conflict is detected.

Object_Size (L)—The DOID generation module 310 determines how many full 1 MB segments are contained in the data object and stores this number as the Object_Size (L).

Object_Size (S)—The DOID generation module 310 determines how many 4K blocks (beyond the Object_Size (L)) are contained in the data object and stores this number as the Object_Size (S).

Process—The DOID generation module 310 assigns an initial value of 01h to indicate that a write is in-process. The initial value is later changed to 00h when the write process is complete. In one embodiment, different values are used to indicate different attributes.

Archive—The DOID generation module 310 assigns an initial value of 00, meaning that the data object has not been archived. Later, the initial value is overwritten if the data object is moved to an archival storage system. An overwrite value of 01 indicates that the data object was moved to a local archive, an overwrite value of 02 indicates a site 2 archive, and so on.

The storage hypervisor (SH) storage location module 320 takes as input a data object identification (DOID), determines the one or more storage nodes associated with the DOID, and outputs the one or more storage nodes (indicated by storage node identifiers). For example, the SH storage location module 320 a) obtains the DOID-L from the DOID (e.g., by extracting the first four bytes from the DOID), b) queries the data location table 360 with the DOID-L to obtain the one or more storage nodes to which the DOID-L is mapped, and c) outputs the obtained one or more storage nodes (indicated by storage node identifiers).

The storage hypervisor (SH) storage module 330 takes as input an application write request, processes the application write request, and outputs a storage hypervisor (SH) write acknowledgment. The application write request includes a data object (DO) and an application data identifier (e.g., a file name, an object name, or a range of blocks). In one embodiment, the SH storage module 330 processes the application write request by: 1) using the DOID generation module 310 to determine the DO's pending (i.e., not finalized) DOID; 2) using the SH storage location module 320 to determine the one or more storage nodes associated with the DOID; 3) sending a SH write request (which includes the DO and the pending DOID) to the associated storage node(s); 4) receiving a storage manager (SM) write acknowledgement from the storage node(s) (which includes the DO's finalized DOID); and 5) updating the virtual volume catalog 350 by adding an entry mapping the application data identifier to the finalized DOID.

In one embodiment, updates to the virtual volume catalog 350 are also stored by one or more storage nodes 130 (e.g., the same group of storage nodes that is associated with the DOID). This embodiment provides a redundant, non-volatile, consistent replica of the virtual volume catalog 350 data within the environment 100. In this embodiment, when a storage hypervisor module 125 is initialized or restarted, the appropriate copy of the virtual volume catalog 350 is loaded from a storage node 130 into the storage hypervisor module 125. In one embodiment, the storage nodes 130 are assigned by volume ID (i.e., by each unique storage volume), as opposed to by DOID. In this way, all updates to the virtual volume catalog 350 will be consistent for any given storage volume.

The storage hypervisor (SH) retrieval module 340 takes as input an application read request, processes the application read request, and outputs a data object (DO). The application read request includes an application data identifier (e.g., a file name, an object name, or a range of blocks). In one embodiment, the SH retrieval module 340 processes the application read request by: 1) querying the virtual volume catalog 350 with the application data identifier to obtain the corresponding DOID; 2) using the SH storage location module 320 to determine the one or more storage nodes associated with the DOID; 3) sending a SH read request (which includes the DOID) to one of the associated storage node(s); and 4) receiving a data object (DO) from the storage node.

Regarding steps (2) and (3), recall that the data location table 360 can map one DOID-L to multiple storage nodes. This type of mapping provides the ability to have flexible data protection levels allowing multiple data copies. For example, each DOID-L can have a Multiple Data Location (MDA) to multiple storage nodes 130 (e.g., four storage nodes). The MDA is noted as Storage Manager (x) where x=1-4. SM1 is the primary data location, SM2 is the secondary data location, and so on. In this way, a SH retrieval module 340 can tolerate a failure of a storage node 130 without management intervention. For a failure of a storage node 130 that is “SM1” to a particular set of DOID-Ls, the SH retrieval module 340 will simply continue to operate.

The MDA concept is beneficial in the situation where a storage node 130 fails. A SH retrieval module 340 that is trying to read a particular data object will first try SM1 (the first storage node 130 listed in the data location table 360 for a particular DOID-L). If SM1 fails to respond, then the SH retrieval module 340 automatically tries to read the data object from SM2, and so on. By having this resiliency built in, good system performance can be maintained even during failure conditions.

Note that if the storage node 130 fails, the data object can be retrieved from an alternate storage node 130. For example, after the SH read request is sent in step (3), the SH retrieval module 340 waits a short period of time for a response from the storage node 130. If the SH retrieval module 340 hits the short timeout window (i.e., if the time period elapses without a response from the storage node 130), then the SH retrieval module 340 interacts with a different one of the determined storage nodes 130 to fulfill the SH read request.

Note that the SH storage module 330 and the SH retrieval module 340 use the DOID-L (via the SH storage location module 320) to determine where the data object (DO) should be stored. If a DO is written or read, the DOID-L is used to determine the placement of the DO (specifically, which storage node(s) 130 to use). This is similar to using an area code or country code to route a phone call. Knowing the DOID-L for a DO enables the SH storage module 330 and the SH retrieval module 340 to send a write request or read request directly to a particular storage node 130 (even when there are thousands of storage nodes) without needing to access another intermediate server (e.g., a directory server, lookup server, name server, or access server). In other words, the routing or placement of a DO is “implicit” such that knowledge of the DO's DOID makes it possible to determine where that DO is located (i.e., with respect to a particular storage node 130). This improves the performance of the environment 100 and negates the impact of having a large scale-out system, since the access is immediate, and there is no contention for a centralized resource.

FIG. 4 is a high-level block diagram illustrating the storage manager module 135 from FIG. 1, according to one embodiment. The storage manager (SM) module 135 includes a repository 400, a storage manager (SM) storage location module 410, a storage manager (SM) storage module 420, a storage manager (SM) retrieval module 430, and an orchestration manager module 440. The repository 400 stores a storage manager (SM) catalog 440.

The storage manager (SM) catalog 440 stores mappings between data object identifications (DOIDs) and actual storage locations (e.g., on hard disk, optical disk, flash memory, and cloud). One DOID is mapped to one actual storage location. For a particular DOID, the data object (DO) associated with the DOID is stored at the actual storage location.

The storage manager (SM) storage location module 410 takes as input a data object identification (DOID), determines the actual storage location associated with the DOID, and outputs the actual storage location. For example, the SM storage location module 410 a) queries the storage manager (SM) catalog 440 with the DOID to obtain the actual storage location to which the DOID is mapped and b) outputs the obtained actual storage location.

The storage manager (SM) storage module 420 takes as input a storage hypervisor (SH) write request, processes the SH write request, and outputs a storage manager (SM) write acknowledgment. The SH write request includes a data object (DO) and the DO's pending DOID. In one embodiment, the SM storage module 420 processes the SH write request by: 1) finalizing the pending DOID, 2) storing the DO; and 3) updating the SM catalog 440 by adding an entry mapping the finalized DOID to the actual storage location. The SM write acknowledgment includes the finalized DOID.

Finalizing the pending DOID determines whether the data object (DO) to be stored has the same Base_Hash value as a DO already listed in the storage manager (SM) catalog 440 and assigns a value to the “finalized” DOID appropriately. The DO to be stored and the DO already listed in the SM catalog 440 can have identical hash values in two situations. In the first situation (duplicate DOs), the DO to be stored is identical to the DO already listed in the SM catalog 440. In this situation, the pending DOID is used as the “finalized” DOID. (Note that since the DOs are identical, only one copy needs to be stored, and the SM storage module 420 can perform data deduplication.)

In the second situation (hash conflict), the DO to be stored is not identical to the DO already listed in the SM catalog 440. Since the DOs are different, both DOs need to be stored. If the DO to be stored has the same Base_Hash value as a DO already listed in the storage manager catalog 440, but the underlying data is not the same (i.e., the DOs are not identical), then a hash conflict exists. If a hash conflict does exist, then the SM storage module 420 resolves the conflict by incrementing the Conflict_ID attribute value of the pending DOID to the lowest non-conflicting (i.e., previously unused) Conflict_ID value (for that same Base_Hash), thereby creating a unique, “finalized”, DOID.

If the DO to be stored does not have the same Base_Hash value as a DO already listed in the SM catalog 440, then the pending DOID is used as the “finalized” DOID.

In one embodiment, the SM storage module 420 distinguishes between the first situation (duplicate DOs) and the second situation (hash conflict) as follows: 1) The SM storage module 420 compares the Base_Hash value of the pending DOID (which is associated with the DO to be stored) with the Base_Hash values of the DOIDs listed in the SM catalog 440 (which are associated with DOs that have already been stored). 2) For DOIDs listed in the SM catalog 440 whose Base_Hash values are identical to the Base_Hash value of the pending DOID, the SM storage module 420 accesses the associated stored DOs, executes a second (different) hash function on them, executes that same second hash function on the DO to be stored, and compares the hash values. This second hash function uses a hashing algorithm that is fundamentally different from the hashing algorithm used by the DOID generation module 310 to generate a Base_Hash value. 3) If the hash values from the second hash function match each other, then the SM storage module 420 determines that the DO to be stored and the DO listed in the SM catalog “match” and the first situation (duplicate DOs) applies. 4) If the hash values from the second hash function do not match each other, then the SM storage module 420 determines that the DO to be stored and the DO listed in the SM catalog “conflict” and the second situation (hash conflict) applies.

The storage manager (SM) retrieval module 430 takes as input a storage hypervisor (SH) read request, processes the SH read request, and outputs a data object (DO). The SH read request includes a DOID. In one embodiment, the SM retrieval module 430 processes the SH read request by: 1) using the SM storage location module 410 to determine the actual storage location associated with the DOID; and 2) retrieving the DO stored at the actual storage location.

The orchestration manager module 440 performs storage allocation and tuning among the various storage nodes 130. Only one storage node 130 within the environment 100 needs to include the orchestration manager module 440. However, in one embodiment, multiple storage nodes 130 within the environment 100 (e.g., four storage nodes) include the orchestration manager module 440. In that embodiment, the orchestration manager module 440 runs as a redundant process.

Storage nodes 130 can be added to (and removed from) the environment 100 dynamically. Adding (or removing) a storage node 130 will increase (or decrease) linearly both the capacity and the performance of the overall environment 100. When a storage node 130 is added, data objects are redistributed from the previously-existing storage nodes 130 such that the overall load is spread evenly across all of the storage nodes 130, where “spread evenly” means that the overall percentage of storage consumption will be roughly the same in each of the storage nodes 130. In general, the orchestration manager module 440 balances base capacity by moving DOID-L segments from the most-used (in percentage terms) storage nodes 130 to the least-used storage nodes 130 until the environment 100 becomes balanced.

Recall that the data location table 360 stores mappings (i.e., associations) between DOID-Ls and storage nodes. The aforementioned data object redistribution is indicated in the data location table 360 by modifying specific DOID-L associations from one storage node 130 to another. Once a new storage node 130 has been configured and the relevant data object has been copied, a storage hypervisor module 125 will receive a new data location table 360 reflecting the new allocation. Data objects are grouped by individual DOID-Ls such that an update to the data location table 360 in each storage hypervisor module 125 can change the storage node(s) associated with the DOID-Ls. Note that the existing storage nodes 130 will continue to operate properly using the older version of the data location table 360 until the update process is complete. This proper operation enables the overall data location table update process to happen over time while the environment 100 remains fully operational.

In one embodiment, the orchestration manager module 440 also insures that a subsequent failure or removal of a storage node 130 will not cause any other storage nodes to become overwhelmed. This is achieved by insuring that the alternate/redundant data from a given storage node 130 is also distributed across the remaining storage nodes.

DOID-L assignment changes (i.e., modifying a DOID-L's storage node association from one node to another) can occur for a variety of reasons. If a storage node 130 becomes overloaded or fails, other storage nodes 130 can be assigned more DOID-Ls to rebalance the overall environment 100. In this way, moving small ranges of DOID-Ls from one storage node 130 to another causes the storage nodes to be “tuned” for maximum overall performance.

Since each DOID-L represents only a small percentage of the total storage, the reallocation of DOID-L associations (and the underlying data objects) can be performed with great precision and little impact on capacity and performance. For example, in an environment with 100 storage nodes, a failure (and reconfiguration) of a single storage node would require the remaining storage nodes to add only ˜1% additional load. Since the allocation of data objects is done on a percentage basis, storage nodes 130 can have different storage capacities. Data objects will be allocated such that each storage node 130 will have roughly the same percentage utilization of its overall storage capacity. In other words, more DOID-L segments will typically be allocated to the storage nodes 130 that have larger storage capacities.

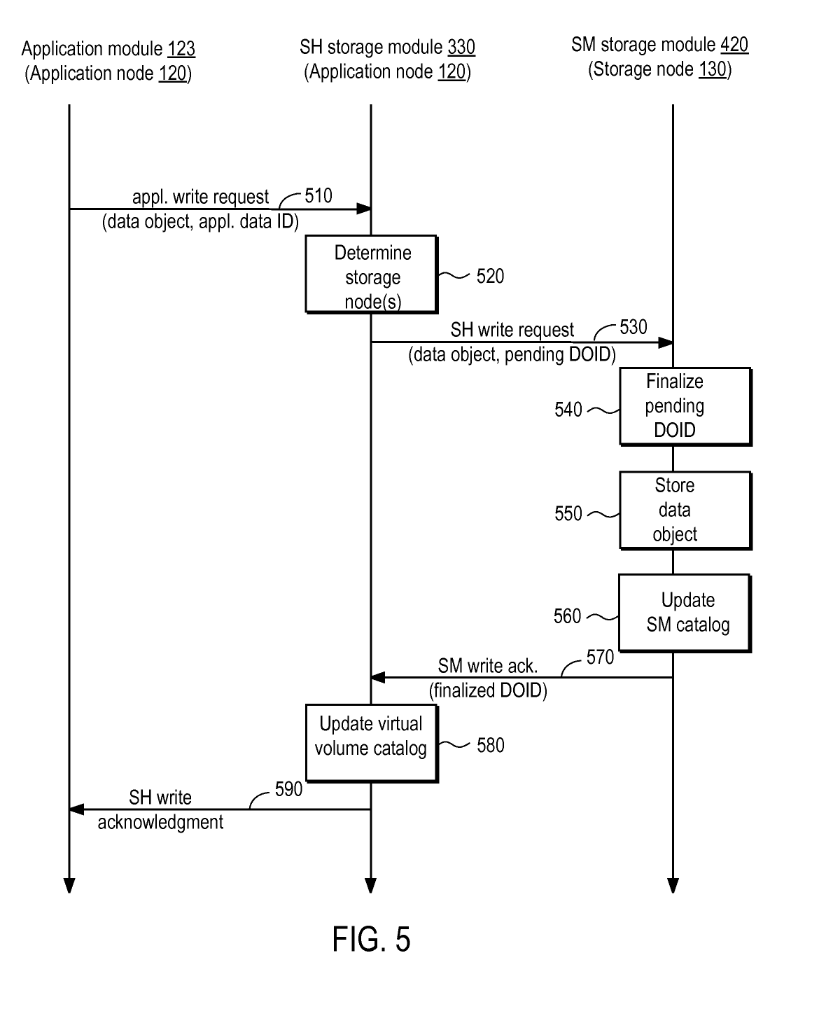

FIG. 5 is a sequence diagram illustrating steps involved in processing an application write request, according to one embodiment. In step 510, an application write request is sent from an application module 123 (on an application node 120) to a storage hypervisor module 125 (on the same application node 120). The application write request includes a data object (DO) and an application data identifier (e.g., a file name, an object name, or a range of blocks). The application write request indicates that the DO should be stored in association with the application data identifier.

In step 520, the SH storage module 330 (within the storage hypervisor module 125 on the same application node 120) determines one or more storage nodes 130 on which the DO should be stored. For example, the SH storage module 330 uses the DOID generation module 310 to determine the DO's pending (i.e., not finalized) DOID and uses the SH storage location module 320 to determine the one or more storage nodes associated with the DOID.

In step 530, a storage hypervisor (SH) write request is sent from the SH module 125 to the one or more storage nodes 130 (specifically, to the storage manager (SM) modules 135 on those storage nodes 130). The SH write request includes the data object (DO) that was included in the application write request and the DO's pending DOID. The SH write request indicates that the SM module 135 should store the DO.

In step 540, the SM storage module 420 (within the storage manager module 135 on the storage node 130) finalizes the pending DOID.

In step 550, the SM storage module 420 stores the DO.

In step 560, the SM storage module 420 updates the SM catalog 440 by adding an entry mapping the DO's finalized DOID to the actual storage location where the DO was stored (in step 540).

In step 570, a SM write acknowledgment is sent from the SM storage module 420 to the SH module 125. The SM write acknowledgment includes the finalized DOID.

In step 580, the SH storage module 330 updates the virtual volume catalog 350 by adding an entry mapping the application data identifier (that was included in the application write request) to the finalized DOID.

In step 590, a SH write acknowledgment is sent from the SH storage module 330 to the application module 123.

Note that while DOIDs are used by the SH storage module 330 and the SM storage module 420, DOIDs are not used by the application module 123. Instead, the application module 123 refers to data using application data identifiers (e.g., file names, object name, or ranges of blocks).

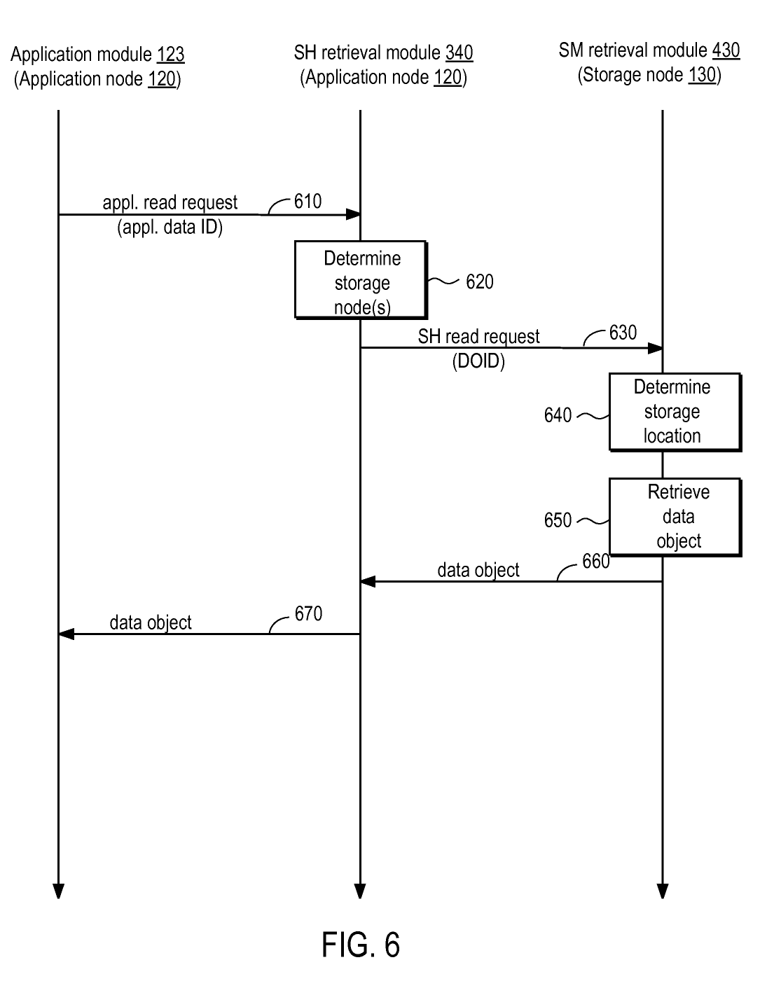

FIG. 6 is a sequence diagram illustrating steps involved in processing an application read request, according to one embodiment. In step 610, an application read request is sent from an application module 123 (on an application node 120) to a storage hypervisor module 125 (on the same application node 120). The application read request includes an application data identifier (e.g., a file name, an object name, or a range of blocks). The application read request indicates that the data object (DO) associated with the application data identifier should be returned.

In step 620, the SH retrieval module 340 (within the storage hypervisor module 125 on the same application node 120) determines one or more storage nodes 130 on which the DO associated with the application data identifier is stored. For example, the SH retrieval module 340 queries the virtual volume catalog 350 with the application data identifier to obtain the corresponding DOID and uses the SH storage location module 320 to determine the one or more storage nodes associated with the DOID.

In step 630, a storage hypervisor (SH) read request is sent from the SH module 125 to one of the determined storage nodes 130 (specifically, to the storage manager (SM) module 135 on that storage node 130). The SH read request includes the DOID that was obtained in step 620. The SH read request indicates that the SM module 135 should return the DO associated with the DOID.

In step 640, the SM retrieval module 430 (within the storage manager module 135 on the storage node 130) uses the SM storage location module 410 to determine the actual storage location associated with the DOID.

In step 650, the SM retrieval module 430 retrieves the DO stored at the actual storage location (determined in step 640).

In step 660, the DO is sent from the SM retrieval module 430 to the SH module 125.

In step 670, the DO is sent from the SH retrieval module 340 to the application module 123.

Note that while DOIDs are used by the SH retrieval module 340 and the SM retrieval module 430, DOIDs are not used by the application module 123. Instead, the application module 123 refers to data using application data identifiers (e.g., file names, object name, or ranges of blocks).

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for processing a write request that includes a data object, the method comprising:
executing a hash function on the data object, thereby generating a hash value that includes a first portion and a second portion;
querying a data location table with the first portion, thereby obtaining a storage node identifier; and
sending the data object to a storage node associated with the storage node identifier.

2. The method of claim 1, wherein querying the data location table with the first portion results in obtaining both the storage node identifier and a second storage node identifier, the method further comprising:
sending the data object to a storage node associated with the second storage node identifier.

3. The method of claim 1, wherein a length of the first portion is four bytes.

4. The method of claim 1, wherein the storage node identifier comprises an Internet Protocol (IP) address.

5. The method of claim 1, wherein the write request further includes an application data identifier, the method further comprising:
generating a pending data object identification (DOID) based on the data object;
sending the pending DOID to the storage node;
receiving, from the storage node, a finalized data object identification (DOID); and
updating a virtual volume catalog by adding an entry mapping the application data identifier to the finalized DOID.

6. The method of claim 5, wherein generating the pending DOID comprises concatenating the hash value and a conflict value.

7. The method of claim 5, wherein the application data identifier comprises a file name, an object name, or a range of blocks.

8. A method for processing a write request that includes a data object and a pending data object identification (DOID), wherein the pending DOID comprises a hash value of the data object, the method comprising:
finalizing the pending DOID, thereby generating a finalized data object identification (DOID);
storing the data object at a storage location;
updating a storage manager catalog by adding an entry mapping the finalized DOID to the storage location; and
outputting the finalized DOID.

9. The method of claim 8, wherein the pending DOID further comprises a conflict value, and wherein finalizing the pending DOID comprises:
determining whether a hash conflict exists;
responsive to determining that the hash conflict exists:
modifying the pending DOID by incrementing the pending DOID's conflict value to a lowest non-conflicting value; and
setting the finalized DOID equal to the modified pending DOID; and
responsive to determining that the hash conflict does not exist:
setting the finalized DOID equal to the pending DOID.

10. The method of claim 9, wherein determining whether the hash conflict exists comprises determining whether the storage manager catalog includes an entry mapping a second data object's data object identification (DOID), wherein the second data object's DOID comprises a hash value identical to the pending DOID's hash value, and wherein the second data object differs from the data object included in the write request.

11. The method of claim 10, wherein determining whether the storage manager catalog includes the entry mapping the second data object's DOID comprises:
determining, based on a first hash function, whether the second data object matches the data object included in the write request; and
determining, based on a second hash function, whether the second data object matches the data object included in the write request.

12. A non-transitory computer-readable storage medium storing computer program modules for processing a read request that includes an application data identifier, the computer program modules executable to perform steps comprising:
querying a virtual volume catalog with the application data identifier, thereby obtaining a data object identification (DOID), wherein the DOID comprises a hash value of a data object, and wherein the hash value includes a first portion and a second portion;
querying a data location table with the first portion, thereby obtaining a storage node identifier; and
sending the DOID to a storage node associated with the storage node identifier.

13. The computer-readable storage medium of claim 12, wherein the steps further comprise receiving the data object.

14. The computer-readable storage medium of claim 12, wherein querying the data location table with the first portion results in obtaining both the storage node identifier and a second storage node identifier, and wherein the steps further comprise:
waiting for a response; and
responsive to no response being received within a specified time period, sending the DOID to a storage node associated with the second storage node identifier.

15. A system for processing a read request that includes a data object identification (DOID), wherein the DOID comprises a hash value of a data object, and wherein the hash value includes a first portion and a second portion, the system comprising:
a non-transitory computer-readable storage medium storing computer program modules executable to perform steps comprising:
querying a storage manager catalog with the first portion, thereby obtaining a storage location; and
retrieving the data object from the storage location; and
a computer processor for executing the computer program modules.

16. The system of claim 15, wherein the steps further comprise outputting the data object.
